(19) United States
(12) Patent Application Publication
(10) Pub. No.: US 2026/0127965 A1
(43) Pub. Date: May 7, 2026

(54) TRAFFIC WARNING SYSTEM FOR BLIND INTERSECTIONS

(71) Applicant: Charles W Hartman, JR., Charlottesville, VA (US)

(72) Inventor: Charles W Hartman, JR., Charlottesville, VA (US)

(21) Appl. No.: 19/267,516

(22) Filed: Jul. 12, 2025

Related U.S. Application Data
(60) Provisional application No. 63/715,200, filed on Nov. 1, 2024.

(51) Int. Cl. G08G 1/16

(52) U.S. Cl. CPC G08G 1/164; G08G 1/166

(57) ABSTRACT

The present invention is directed to a warning system for use in visually obstructed environments includes multiple traffic panels having a housing supporting a least one detector and at least one indicator, a communication means to transmit motion signals registered by the detector between the traffic panels, and a power supply. Each of the multiple traffic panels is positionably adjustable and faces a direction that is unviewable from at least one other direction and the motion signals are transmitted from one detector in a traffic panel to an indicator in at least one other traffic panel. The warning signal provided by one the multiple traffic panels warns of motion within the line of sight of the detector of another of the multiple traffic panels.

### FIELD OF THE INVENTION

The present invention relates generally to a warning system, and more particularly to a device having a system to detect motion and provides alerts, visual and/or auditory, of oncoming movement in visually obstructed environments. In particular, the invention concerns facilitating safe navigation through blind intersections.

### SUMMARY

The present invention is directed to a warning system for use in visually obstructed environments including multiple traffic panels having a housing supporting a detector and an indicator, a communication means to transmit motion signals registered by the detector between the traffic panels, and a power supply. Each of the multiple traffic panels is positionably adjustable and faces a direction that is unviewable from at least one other direction and the motion signals are transmitted from one detector in a traffic panel to an indicator in at least one other traffic panel. The warning signal provided by one the multiple traffic panels warns of motion within the line of sight of the detector of another of the multiple traffic panels.

The device, in one embodiment, is a central base with two adjustable wings, or traffic panels. Each wing contains an LED light and a motion sensor. When set up, each wing is adjusted so that it faces a traffic lane. When a moving object (car, truck, bicycle, or even a deer) is sensed by the motion detector, the LED light on the opposite side illuminates, warning traffic of an oncoming hazard.

In an alternate embodiment a base with wings operates in a similar fashion. In addition to the LED lights and motion sensors on the wings, a third LED light and motion sensor combination are placed on the body of the main base, facing the exiting traffic. It is designed, for example, to improve the safety of road entry from a driveway or road where views of oncoming traffic are obstructed. Before the driver exits, he can see if traffic is approaching from either direction.

In this embodiment if traffic is approaching from either direction, the third LED light (the one facing the exiting driver) illuminates. Simultaneously, the lights on the wings can be set to both illuminate (steady or flashing), warning the oncoming traffic of the exiting driver. Alternatively, the lights can be split (one for left, and the other for right, facing the driver) indicating to the exiting driver which direction the oncoming traffic is coming from.

In addition, a timer may be added to keep the warnings on for a brief period since the exiting car will likely be stationary, and the motion sensor would therefore no longer be sensing motion.

All embodiments can be powered by AC current (if available) or, for remote settings, rechargeable batteries, recharged by the use of solar panels. As disclosed hereinafter, the electronics and internal power sources can be maintained either within a central base or within each of the separate wings. The central base can be located at any convenient location, e.g., adjacent to the wings, on the ground or positioned on the support member.

This device can be pole-mounted using an adjustable swivel base or attached using bolts attached to the side of the base portion or a bracket. Where applicable, the device can be hung from a support or placed on a structure.

All versions contain the operating circuitry within the base, adjacent to or separate from the wing, or wing portion, and all parts intended for outdoor use are water and weatherproof for sustained outdoor use. When used indoors, the applicable materials of manufacture can be modified and will be known to those skilled in the art.

### BRIEF DESCRIPTION OF THE DRAWINGS

FIG. 1 is a front plan view of an embodiment with dual wings on either side of a base containing the electronics and each wing incorporating a detector, optional shield, and indicator, in accordance with the disclosed invention;

FIG. 2 is a top view of the embodiment of FIG. 1 showing the dual wings in a position to detect and indicate oncoming traffic, in accordance with the disclosed invention;

FIG. 3 is a front plan view of an alternate embodiment with dual wings, each wing containing a detector and indicator, with the addition of a detector and indicator in the center base, in accordance with the disclosed invention;

FIG. 4 is a front plan view of an additional embodiment having, in addition to the two wings, dual indicators on the center base panel to indicate the direction of the oncoming traffic, in accordance with the disclosed invention;

FIG. 5 is an exploded side view of a swivel mount for the wings to enable horizontal and vertical movement, in accordance with the disclosed invention;

FIG. 6 is a side view of the assembled swivel mount of FIG. 5, in accordance with the disclosed invention;

FIG. 7 is a side view of an adjustable motion sensor, in accordance with the disclosed invention;

FIG. 8 is an exploded view of the adjustable motion sensor of FIG. 7, in accordance with the disclosed invention;

FIG. 9 is a side view of a mounting bracket, having interior and exterior threads, for use on the top of a threaded pipe, in accordance with the disclosed invention;

FIG. 10 side view of a mounting bracket for use on the top of an unthreaded pipe, in accordance with the disclosed invention;

FIG. 11a is the side view of a L shaped bracket, in accordance with the disclosed invention;

FIG. 11b is a front view of the L shaped bracket of FIG. 11a, in accordance with the disclosed invention;

FIG. 12 is an alternate embodiment illustrating the indicators and detectors on separate traffic panels with wired connections to the base panel, in accordance with the disclosed invention;

FIG. 13 is an additional example embodiment of the disclosed motion detection system with the indicators, electronics, and batteries contained within the individual wings, in accordance with the disclosed invention;

FIG. 14 illustrates a back view of the embodiment of FIG. 13 showing an example hinge connection for the wings, in accordance with the disclosed invention;

FIG. 15 is a top view of the embodiment of FIG. 13 illustrating the wings on the same plane, in accordance with the disclosed invention;

FIG. 16 is a top view of the embodiment of FIG. 13 angled for use, in accordance with the disclosed invention;

FIG. 17 is a top view of the embodiment of FIG. 13 in a closed position for shipping, in accordance with the disclosed invention;

FIG. 18 is a front view of an embodiment having a center mounting panel with the wings attached on either side of the mounting panel, in accordance with the disclosed invention;

FIG. 19 is an example of the housing interior and back plate of a wing showing example battery, circuit board, sensor, and indicator placement, in accordance with the disclosed invention;

FIG. 20 is a side view of the wing of FIG. 19; and,

FIG. 21 is a front view of an alternate embodiment of the disclosed device wherein the power connections are contained within a base unit located at ground level.

### DETAILED DESCRIPTION OF THE INVENTION

### Definitions

As used herein the term “indicator” shall refer to a device that provides visual and/or auditory alert signals to indicate detection of movement;

As used herein the term “traffic” shall refer to any object, including but not limited to humans, vehicles, and/or animals, moving within sensor range;

As used herein the terms “blind spot” and “blind intersection” shall refer to any area or location where the movement or approach of a human or object cannot be seen by another human, including but not limited to traffic intersections, entrances, and sharp turns;

As used herein the terms “detector” and “sensor” will be used interchangeably and shall refer to any device that can register motion.

As used herein the term “panel” shall refer to a structural unit of the device that contains at least one element critical to the operation of the warning system. Multiple panels are used to configure the warning system of the present invention.

As used herein the terms “base” or “central base” are used interchangeably and shall refer a central operation hub that facilitates physical connection, electrical connection, and communication between multiple panels. The base can be located adjacent to or distanced from the traffic panels and connected via wire or wireless means depending upon the terrain.

As used herein the term “base panel” shall refer to a panel containing the central base/operation hub of the device.

As used herein the term “base unit” shall refer to a separate structure containing the central base/operation hub of the device.

As used herein the terms “wings” “panels” or “traffic panels” are used interchangeably and shall refer to the adjustable panels of the device that monitor traffic and provide traffic alerts using the detectors and indicators along with applicable electronics.

The disclosed warning system improves traffic safety when navigating blind spots or sharp curves by detecting moving objects and providing a warning indicator. When set up, multiple traffic panels (wings) are placed so that each faces a designated traffic lane. When a moving object such as a car, truck, bicycle, pedestrian, or animal is sensed by the motion detector on one traffic panel, a warning indicator on at least one other traffic panel activates, thereby warning traffic of an oncoming, possibly unseen, hazard. The warning system of the present invention is especially useful on winding or hilly roads, obstructed intersections, and blind entries. While the system of the present invention is most directly applicable to outdoor traffic use, the system could also be useful in indoor environments such as warehouses.

The warning system of the present invention includes at least two traffic panels with one or more of the traffic panels, each having at least one detector for detecting a traffic situation and with one or more of the traffic panels each having at least one indicator for displaying an alert about the traffic situation. Each traffic panel can be a stand-alone unit or can be physically connected to another traffic panel, a base panel, or a mounting panel. When a base panel configuration is used, the base panel functions as a central hub operating the warning system by providing physical, electrical, and communications connections between multiple panels. When a base panel configuration is not used, all electrical and communication elements are contained within each traffic panel or placed remotely in a base unit, such as along the support, on the ground, or in a separate structure. Regardless of the physical configuration, each traffic panel is in communication with another traffic panel and/or central base. The warning system can utilize a variety of panel configurations depending on the use and location of the warning system and example embodiments are set forth herein.

### Device Configuration and Embodiments

Each traffic panel and base panel of the present invention is configured with a housing sufficiently sized to hold the necessary electronics and communications means, to be appropriately visible to traffic, and to be mountable in a given situation. Further, a surface of the housing supports the detector and indicator of each traffic panel. Traffic panels can typically range in size from those sized to alert moving traffic to those alerting indoor warehouse traffic. The sizing can be adjusted as determined by end use and will be known by those skilled in the art.

The base dimensioning must be sufficient to house the electronics and, if used, solar panel connections, and/or solar panels. If the base panel requires a specific size to accommodate the mounting needs and provide stability, the sizing can be adjusted accordingly. The base in the embodiments illustrated herein contain, at the minimum, the wiring/electronics to connect the detectors and indicators to a power source as well as the detectors and indicators. The batteries/power connectors required to power the sensors and indicators and, depending upon end use, a processor are, in some embodiments incorporated within the wings and in some embodiments within a central base. The wiring from the wings containing the sensor and indicator can be passed through the apparatus connecting the wings to a central base or through external “pig tails” that are protected from the elements. Although referred to as wings herein, the wings are not required to be physically attached to the base and can be placed a distance apart.

The illustrations herein are sized for clarity, and it should be noted that although the wing thickness can vary, the wings must be dimensioned to internally accommodate the sensors and circuitry applicable to that embodiment. Additionally, the overall size of the wings and base can be varied to facilitate the applicable sized indicator for optimal visibility depending on end use locations and traffic patterns. The illustrations herein show the indicators positioned at the top of the wing with the sensor below; however, this placement can also be reversed depending upon end use.

The materials of manufacture can be any material, such as 3D printable materials, moldable materials, composites, steel, aluminum, etc., that are applicable to the environment to which the system will be placed. All exposed electrical wiring should be sealed in a manner known in the art.

Although the disclosed system is not a replacement for intersection traffic lights, it must still meet all Federal requirements, and any models that are in or open to public access must meet the criteria as outlined in the Manual on Uniform Traffic Control Devices (MUTCD) as issued by the US Department of Transportation Federal Highway Administration. As stated, “The MUTCD audience includes, but is not limited to, state and local highway agencies, public officials, owners of private roads open to public travel, the insurance industry, law enforcement agencies, incident management personnel, maintenance personnel, academic institutions, private industry, and planning, construction, and engineering organizations.” https://mutcd.fhwa.dot.gov/kno-overview.htm

The housing dimensions, lens size, and mounting height and methods of traffic lights depends on end use with the average diameter of the lenses used for traffic lights being approximately 8 to 16 inches. The standard material for lenses are polycarbonate and glass or other materials meeting the MUTCD requirement. The foregoing dimensions and material requirements are being provided for information purposes and any dimension and/or material changes in the disclosed device will be based on end use. In most applications, the disclosed device would be used at blind corners or spots at smaller intersections or residential areas and would be dimensioned accordingly.

The mounting methods disclosed herein are applicable for public use only when they adhere to MUTCD regulations. The adherence to MUTCD regulations also applies to the material of manufacture for the panels and base panels as well as any power box being used.

When used on private property that is not accessible by the public or in warehouses, the MUTCD requirements do not need to be met, and any convenient mounting method can be used. Additionally, sizing and design can be modified to suit the end use.

In addition to the lights and mounts being regulated by MUTCD, any indicators used in the system are subject to federal regulations. Sensor technology applicable for use as traffic detectors are described in Chapter 1, Traffic Detector Handbook: Third Edition—Volume I (https://www.fhwa.dot.gov/publications/research/operations/its/06108/01.cfm) The specific sensor from the federally approved sensors will be based on the end application and will be known by those knowledgeable with federal regulations.

Some of the disclosed power supply designs may not meet federal regulations and should be adjusted accordingly. Especially when being used at publicly accessible intersections, it is preferred that when using a central power supply, the power box is placed at ground level in order to enable ease of repair and/or battery replacement. Other locations for the placement of a base unit will be dependent upon end use, environment and applicable regulations. However, for private property or warehouse use the power source can be located at any convenient location.

In addition to MUTCO, other federal agencies, such as Federal Motor Vehicle Safety Standards, National Highway Traffic Safety Administration, Federal Highway Administration, etc. regulate traffic signals, and such regulations are periodically updated. As such, the design of the disclosed device should be easily updated. For example, easy replacement of the elements, such as light and sensors and updating of software.

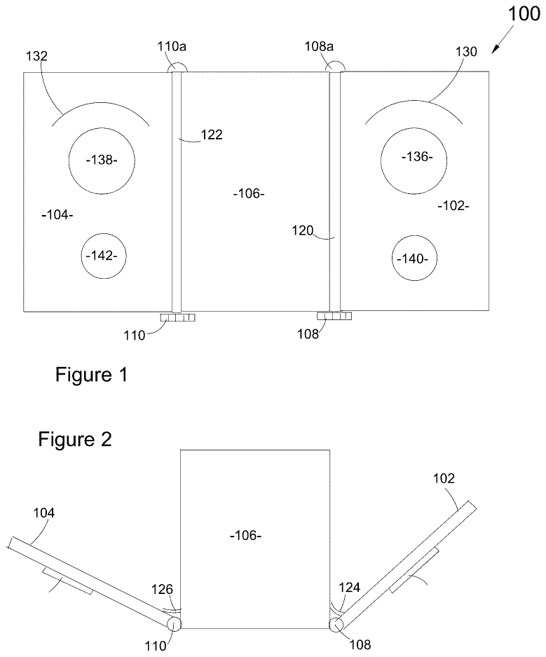

In one embodiment, the device of the warning system is a base with two positionably adjustable wings preferably located on opposite sides of the base. Each wing contains at least one detector or motion sensor and at least one warning indictor such as an LED light. As previously noted, when properly set up, each wing is adjusted so that it faces a designated traffic lane or path. When a moving object is sensed by the motion detector, the LED light on the opposite wing illuminates, warning traffic of an oncoming hazard. This embodiment of a dual wing blind spot signal device 100 is illustrated in FIGS. 1 and 2 and comprises two positionably adjustable wings 102 and 104 movably attached to a stationary center base panel 106. The adjustable wings 102 and 104 in this embodiment are attached to the base panel 106 by hinges 120 and 122 as illustrated in FIG. 1, by multiple smaller hinges, or by swivel mount as illustrated in FIG. 6. In the illustrated embodiment, the hinges 120 and 122 are compression hinges having a knob or bolt nut as a tensioner 108 and 110 respectively, each tensioner having a head 108a and 110a. The tensioners 108 and 110 are used to lock the adjustable wings 102 and 104 at the desired angle, preventing unintentional movement. Alternatively, the bolts can be reversed with the bolt head 108a and 110a being at the bottom of the hinge 120 and 122 and the tensioner 108 and 110 at the top. Other methods of maintaining tension to lock the hinges in place will be dependent upon the hinge or swivel attachment used and will be evident to those skilled in the art. Regardless of the attachment mechanism used, a key feature of the disclosed device is the positional adjustability of the traffic panels in order to accurately detect motion in irregular, dynamic, and/or restricted environments, particularly rural outdoor areas. Once appropriately adjusted and locked upon installation, each traffic panel can be subsequently modified as needed to keep up with conditions.

Each of the two adjustable wings 102 and 104 contains an indicator 136 and indicator 138, respectively. In most uses the indicators 136 and 138 will be LED lights however other lights or indicators can be used. LED lights are preferable due to their intensity and ability, if programmed accordingly, to change color. Although in the majority of applications it will be preferable that the indicator be visual, audio or a combination of visual and audio can be used as well as multiple of each.

In the illustrated embodiment, both adjustable wing 102 and adjustable wing 104 each contain a shade 130 and shade 132, respectively. The shades 130 and 132 are positioned above indicator 136 and indicator 138 and serve to shield the indicators 136 and 138 from the glare created by sun and/or other light sources as well as weather. The size and depth of the shades 130 and 132 will be dependent upon the ambient light and can be altered depending upon the end use. Alternatively, cylinders, similar to those used on traffic lights, can surround each of the indicators to further reduce glare where necessary. It should be noted that any method to reduce glare must not block visibility of the indicators from users, thereby causing safety concerns.

As illustrated herein, the motion sensors 140 and 142 have been placed at the lower portion of each adjustable wing 102 and 104. The type of motion sensors 140 and 142 can be varied depending upon end use. For example, in automotive detection a long-range PIR sensor, covering from 65 to 328 feet (20 to 100 meters) meeting Federal standards would be required, while in an indoor situation or private property, shorter range sensors would be used. Given the travel speed and stopping time for vehicles, sensors typically register motion from at least 100 feet away. This is important as a vehicle traveling at only 20 mph can cover about 30 feet in once second, so even a slow car 100 feet away can become a problem at a blind intersection within 4 seconds. It is critical that the device of the present invention be capable of real time sensor transmission and that the sensors not be set with a delay period in order for indication of movement to be immediate. Accordingly, hardwired sensors and transmission systems are preferred though reliable wireless systems can be utilized in minimal-interference situations when needed. When applicable to the situation, shields or cylinders can be used adjacent to the sensors to limit or direct the area of activation, or the area of activation can also be controlled electronically. The optimal method will be known to those skilled in the art.

Motion detected by the motion sensor 140 in adjustable wing 102 activates the indicator 138 in wing 104 while motion detected by the sensor 142 activates the indicator 136. In this way, the traffic drawing near the side viewing indicator 136 will be warned of the approach of oncoming traffic through the activation of detector 142. Depending upon application and manufacture preferences, multiple indicators can be incorporated. For example, traffic approaching and activating motion sensor 140 can cause indicator 138 to flash or indicate red while activating the opposing indicator 136 to display a flashing yellow, thereby warning both drivers. Alternate signals can be used such as increased flash rate based on proximity, green to yellow to red lights, etc.

In FIG. 2 the adjustable wings 102 and 104 as viewed from the top of the device have been angled in order to face the motion sensors 140 and 142 and indicators 136 and 138 toward oncoming traffic. As stated above, once positioned, the adjustable wings 102 and 104 would be locked in place using the tensioners 108 and 110 (FIG. 1). The adjustable wings 102 and 104 do not need to be angled at the same degree from the base panel 106 and sufficient “play” should be left in the electrical wiring 124 and 126 to enable the adjustable wings 102 and 104 to be fully opened to at least right angles from the base 106.

The electrical communication between the adjustable wings 104 and 102 and the base panel 106 can be any number of methods that will be known to those skilled in the art utilizing wired or wireless elements, or a combination of both, but must be high-speed and reliable to provide for real time sensor transmission. In the swivel mount disclosed hereinafter the wiring will be threaded through the interior of the mount or run on the exterior as illustrated.

Although the example method of providing the tension required to lock the hinges into position, as illustrated herein, is a bolt, it should be noted that any method, such as a threaded rod with nuts at each end, etc., can be used to secure the wings in position. In most situations it would be preferable to retain the ability to alter the angle of the wings, however in some situations the angles can be permanently secured in a single position. The hinges illustrated herein are a single hinge per wing connection. However, if required for a particular end-use multiple hinges can also be used along the length of the wing to base connection.

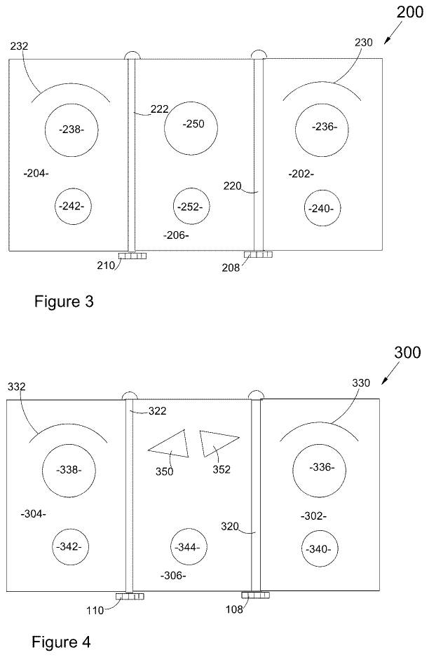

In an alternate embodiment illustrated in FIG. 3, an indicator 250 and detector 252 combination is placed on a base panel 206 and used in conjunction with the two traffic panels 204 and 202 with the base panel 206 facing road entry traffic from a direction different than the designated wing traffic panel 202 and 204 lanes. This embodiment is designed, for example, to improve the safety of road entry from a driveway or road where views of oncoming traffic are obstructed. Before the driver enters the road, approaching, unseen traffic is detected from either direction. In this embodiment, if traffic is approaching from either direction, the LED light of the base indicator (the one facing the entering driver) illuminates. Simultaneously, the LED indicator lights on the wings can be set to both illuminate (steady or flashing), warning the oncoming traffic of the entering driver. Alternatively, the base panel indicator can be split with one signal for left and another signal for right indicating to the entering driver from which direction the oncoming traffic is coming. In this embodiment, along with all embodiments disclosed herein, a timer may be added to keep the indicators on for a predetermined period since the exiting car will most likely be stationary, and any sensor based on motion would therefore no longer be activated. This delay in deactivation of the sensors can be applied to any of the embodiments disclosed herein, with the delay being one of the programmable features for embodiments containing a processor. Alternatively, in addition to the motion detector, a proximity sensor can be added to the indicator facing the entering driver. In situations where the disclosed device is used to exit a driveway, the cars belonging to the home can contain ID that prevents the indicators from turning off until the car has cleared the driveway. As noted heretofore, for safety purposes a delay should not be used on the sensors to detect movement.

An example of this alternate embodiment is illustrated in FIG. 3 with the traffic panels 202 and 204 of system 200 each having a shield 230 and 232, indicators 236 and 238, and detectors 240 and 242. As stated above, bolts in combination with tension nuts 210 and 208 are used in this embodiment to maintain the traffic panels 202 and 204 in position. In this embodiment, the traffic panels 202 and 204 are attached to either side of the central base panel 206 which includes an indicator 250 and detector 252 to provide a third area of detection. This embodiment would position a detector 252 and an indicator 250 facing the oncoming traffic and is applicable for use at a T junction or crossroad. It is designed, for example, to improve the safety of road entry from a driveway or road where views of oncoming traffic are obstructed thereby enabling a driver to see if traffic is approaching from either direction prior to entering the crossroad.

Motion detected by the detector 252 would activate both indictor 236 and indicator 238. Conversely motion detected by detector 240 would not only activate indicator 238 but also indicator 250. In this embodiment, as illustrated, the indicator 250 does not have a shade or cylinder, however depending upon the environment of use, one can be added.

In another example system 300 illustrated in FIG. 4, the wings 302 and 304 each have a shield 330 and 332, indicators 336 and 338, and sensor 340 and 342. The embodiment of FIG. 4 differs in that the base indicator 306 includes directional indicators 350 and 352. The directional indicators 350 and 352 can be triangles, arrows, or other known directional indicators, which are programmed to work independently, thereby indicating the direction of the oncoming traffic. As noted heretofore, the colors can vary as can the flashing vs. solid. The use of the directional indicators 350 and 352 enables the exiting driver to know from which direction the oncoming traffic is approaching.

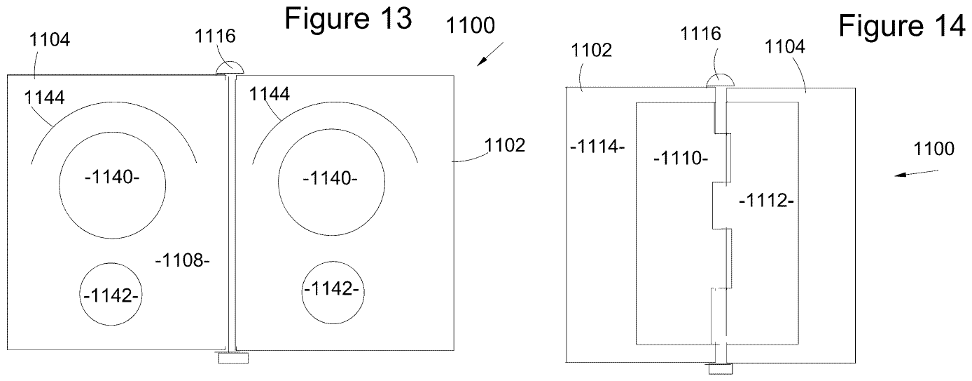

In another embodiment of the traffic warning system, the base panel is absent, and the electronics are contained within each of the two traffic panels which are rotatably connected to one another. FIGS. 13-18 illustrate the alternate embodiment of the detection system 1100 with the center base panel eliminated by placing the electronics within the traffic panels 1102 and 1104. The illustrated embodiment reduces the size of the system 1100, making it easier to ship and mount in tight locations. Although the dimensions of the traffic panels 1102 and 1104 will require some adjustment from the embodiments described heretofore, it will be minimal, especially when used in conjunction with solar panels, thereby reducing the size of the internal batteries. When solar panels are being used, their location should be as close to the device as possible while still being accessible to sunlight. In some embodiments the solar panels can be placed directly onto the central base panel, depending upon access to sun. The placement and size of solar panels will be dependent upon the power requirements and location, all of which will be known to those skilled in the art.

In this embodiment, the traffic panels 1102 and 1104 are rotatably secured to one another through hinges 1110, 1112 and shaft 1116. The hinges 1110 and 1112 are affixed to the back 1114 of the traffic panels 1102 and 1104 and rotate around hinge shaft 1116. The hinges 1110 and 1112 can be 3D printed, along with the back 1114 or adhered in any manner applicable to the materials of manufacture.

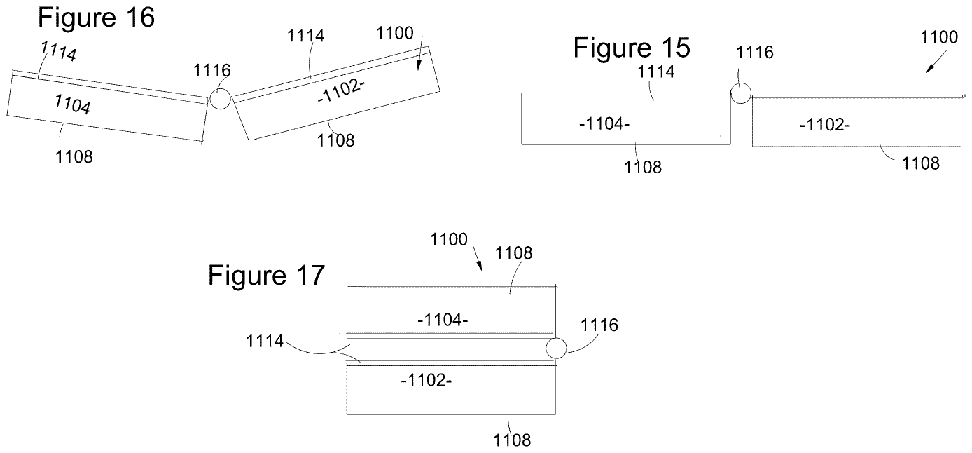

As with all embodiments, the placement of the indicators 1140, shields 1144, and sensors 1142 within the face 1108 of the traffic panels 1104 and 1102 are for example purposes and the positioning of the elements can be reversed. Additionally, for drawing clarity the indicators 1140, shields 1144, and sensors 1142 that would extend beyond the face 1108 have been excluded in FIGS. 15-17. FIG. 15 illustrates a top view of the detection system 1100 with both the traffic panels 1102 and 1104 on the same plane, prior to rotation. In FIG. 16 the traffic panels 1102 and 1104 have been rotated for positioning to enable visibility. In FIG. 17 the traffic panels 1104 and 1102 have been folded around the shaft 1116, to position the backs 1114 parallel. This configuration reduces the size of the system 1100, enabling less costly shipping and storage. Depending upon the configuration of the hinges 1110 and 1112 and shaft 1116, the backs 1114 can touch or be slightly separated. As the wiring between the traffic panels 1102 and 1104 is internal, it is preferable that the wires connecting the two wings be placed as close as possible to the hinge 1116 to prevent breakage.

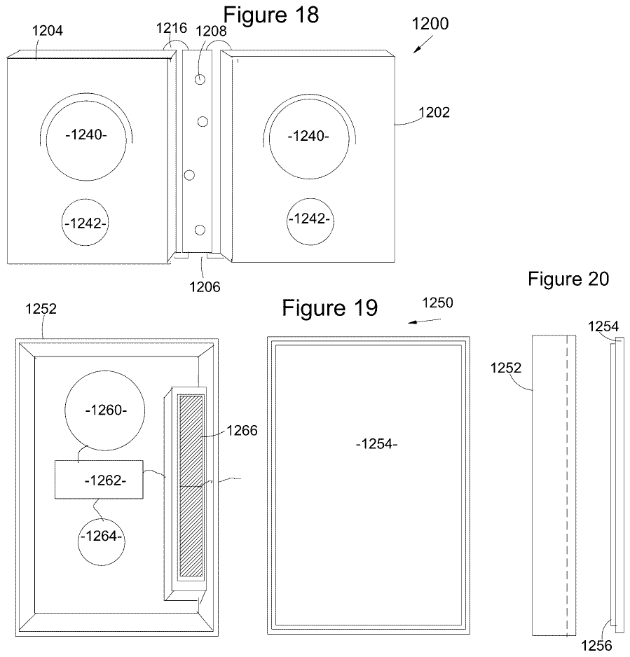

In yet another embodiment, the base panel is absent, and the traffic panels containing the electronics are connected via a mounting plate placed between the panels. As shown in FIG. 18, a mounting panel 1206 has been placed between the traffic panels 1204 and 1202 and rotatably connected through the use of bolts 1216. The mounting panel 1206 is provided with mounting holes 1208 that are used to secure the detection system 1200 to a stand or pole. Although the example illustrated in this figure shows the mounting panel 1206 attached to the back of the traffic panels 1202 and 1204, the depth of the mounting panel 1206 can be altered to extend the entire depth of the traffic panels 1202 and 1204 or any other configuration convenient for manufacture. The critical feature is that the wings 1202 and 1204 be rotatable to position the detectors 1242 and indicators 1240 in the desired direction.

As disclosed heretofore the traffic panels 1202 and 1204 are maintained in position through the pressure created through the tightening of bolts. This is an example method of maintaining the wings in position and other methods, as known in the art, can be used.

FIGS. 19 and 20 illustrate examples of the interior of a traffic panel 1252 and the snap closure between the body 1252 and the back 1254. As seen in FIG. 19 the body 1252 contains the indicator 1260 and detector 1264 in communication with a circuit board 1262. The circuit board 1262, in turn, is in communication with the batteries 1266 or other power source. The back 1254 would fit into the body 1252 and seal the electronics. In this example the back 1254 has a lip 1256 that friction fits into the body 1254. Although not shown, a seal to ensure waterproofing along with a locking mechanism would be preferable, depending upon the end use. Both the electronics layout of FIG. 19 and the closing method of FIG. 20 are simple layouts and other designs; waterproofing and securing methods will be evident to those skilled in the art.

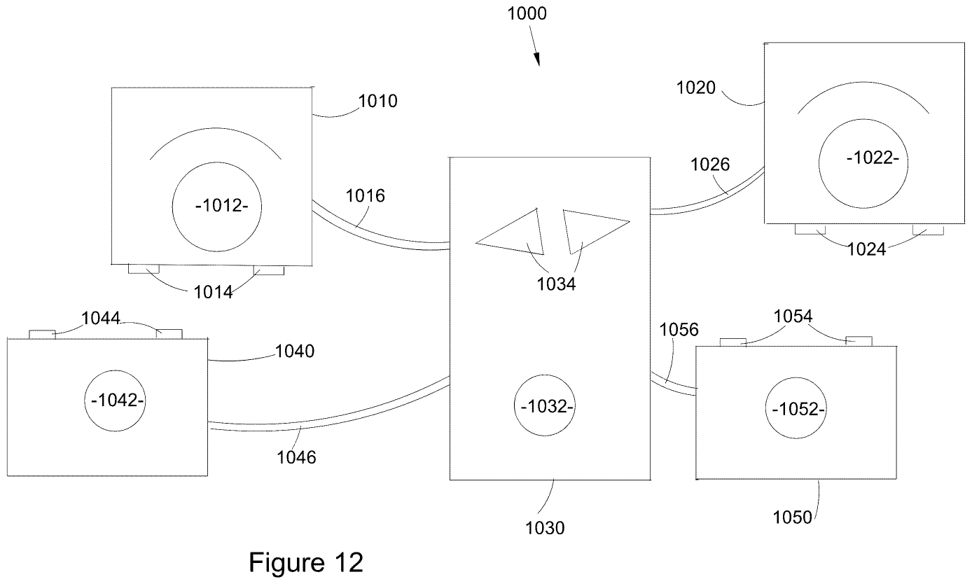

In another example embodiment, the traffic panels can stand alone from a base panel in a variety of configurations while being communicably coupled to each other. FIG. 12 shows example stand-alone base panel 1030 having traffic panel detector and indicator features along with example traffic panels 1010, 1020, 1040, and 1050 having separate detector and indicator units. In FIG. 12 the system 1000 illustrates the indicator units 1010 and 1020 and separate detector units 1040 and 1050, all of which are distanced from the base 1030 and connected only via wires. The indicators 1012 and 1022 are electrically connected to the base panel 1030 through protected wiring 1016 and 1026 while the sensor units 1042 and 1052 are connected to the base panel 1030 through wires 1046 and 1056. In the illustrated system the base unit 1030 also contains indicators 1034 and detector 1032.

In the system 1000 the indicator unit 1010 contains connectors 1014 that interact with connectors 1044 on the detector unit 1040 and indicator unit 1020 contains connector 1024 to interact with connectors 1054 on detector 1050. This design enables the units to be moved, and secured, at the best positioning for detection and indication. Likewise, the detector unit 1020 and indicator unit 1050 can be secured separate from one another, as well as the indicator unit 1010 and detector unit 1040, thereby enabling maximum flexibility. The wires 1016, 1026, 1046 and 1056 are preferably a predetermined length sufficient to allow for versatility in placement. The base 1030 preferably has storage to receive and maintain the excess wires. Although not illustrated, the elements illustrated in FIG. 12 could be communicably coupled wirelessly instead of using a wired configuration.

The connectors 1014 and 1044 enable the indicator unit 1010 and sensor unit 1044 in situations where a single wing is preferred. In the opposite side, the indicator unit 1020 and sensor unit 1050 can be connected to one another via connectors 1024 and 1054. In this embodiment the base unit 1030 contains the third detector 1032 and dual indicators 1034 although the ability to separate the indicator and detector units can be used with any base unit.

Although not illustrated, additional connectors can be added to the base 1030 to receive connectors 1014, 1044, 1024 and 1054. Since there is no directionality to the sensors and indicators, additional connectors would not be needed on the indicators 1012, 1022 and detectors 1042, 1052. In situations where the indicators 1012 and 1022 would be turned to connect with the base 1030, cylinders or other shading may be required in order to provide 360 glare protection.

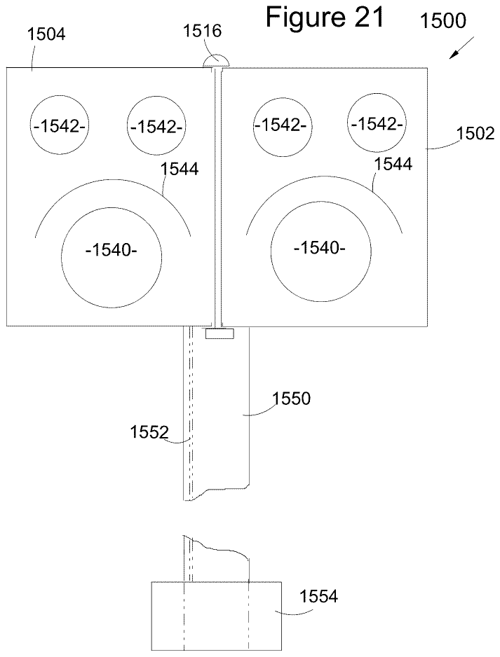

In the embodiment illustrated in FIG. 21 the detection system 1500, as with the system in FIG. 13, has the central base panel eliminated. However, rather than place the electronics within the traffic panels 1502 and 1504, the electronics are located within base unit 1554 and connected to the traffic panels 1502 and 1504 through wiring 1552. This design enables the electronics to be accessed more easily and is especially beneficial when the detection system 1500 is mounted a distance from the ground. Although the base unit 1554 is illustrated located on the ground, it can also be placed along the support 1550. Additionally, this design enables existing power sources to be used either alone or in conjunction with other systems using compatible electronics.

In this embodiment, the traffic panels 1502 and 1504 are rotatably secured to one another, rotating around shaft 1516, as noted heretofore and mounted onto a support 1550. In this figure the placement of the indicators 1540, shields 1544, and detectors 1542 within the traffic panels 1504 and 1502 have been reversed. In this figure, in order to enable the detection of another element affecting the traffic pattern, an additional detector 1542 has added.

It should be noted that any of the embodiments described heretofore can have the electronics located in a base unit placed on the ground or a support.

As an alternate to the above embodiments, the traffic panels with sensors and indicators can comprise communicably coupled opposing sides of a base panel and, when required, communicate with sensors and/or indicators on the front of the base panel as well. This arrangement would not be applicable for all situations and care would need to be taken to ensure sensor visibility.

### Motion Sensor:

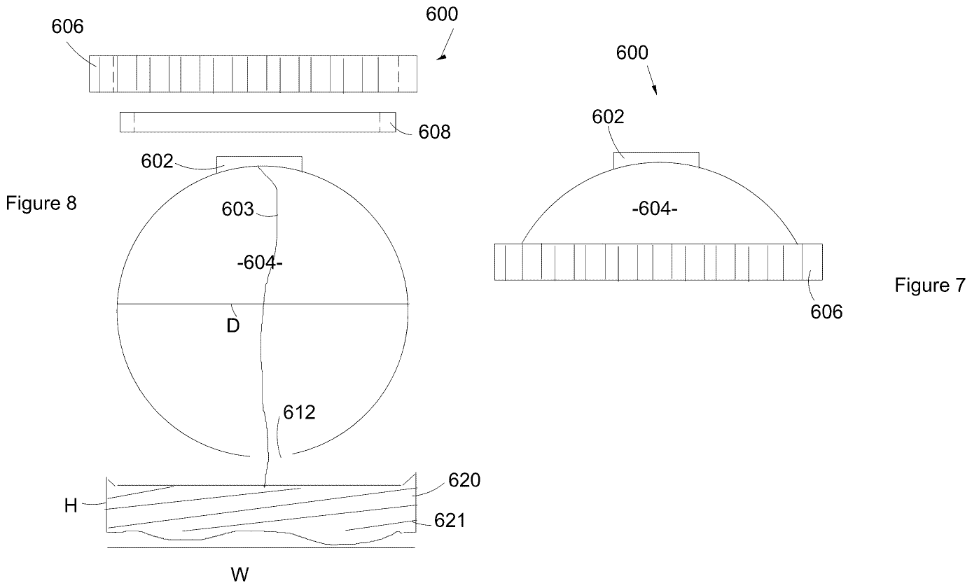

FIGS. 7 and 8 illustrate a positionably adjustable motion sensor assembled (FIG. 7) and exploded to view details (FIG. 8). Although the sensors can be recessed within the wings, there are applications where the ability to adjust the sensor, while leaving the wings in position, is advantageous.

In this sensor embodiment, the motion sensor unit 600 contains a motion sensor 602 mounted on, or in, a circular body 604 that is maintained in connection with a mounting port 620 by a connector ring 606. The open interior diameter of the ring 606 is less than the maximum diameter D of the circular body 604 to enable the circular body 604 to be secured within the ring 606 while retaining mobility. The connector ring 606 has a threaded interior dimensioned to be secured to the exterior threads 621 of the hollow receiving flange 620, thereby enabling the circular body 604 to be tightened at the desired position. As with the swivel mount described heretofore, the surface of the circular body 604 and the interior of the mounting port 620 can have a roughened or striated surface to further prevent unwanted movement once secured.

As seen in these Figures, the base of the circular body 604 has an inlet 612 to enable the sensor 602 wiring 603 to pass through into the wing (not shown). The receiving flange 620 has a width W dimensioned to receive the maximum diameter D of the circular body 604 and a height H sufficient to receive the portion of the circular body 604 not protruding above the connector ring 606. The interior of the connector ring 606 is dimensioned to also receive the flexible gasket 608 while still enabling the threaded portion to interact with threads on the receiving flange 620 affixed to a wing (not illustrated). The flexible gasket 608 is used to prevent moisture from entering the rotatable sensor 602.

To assemble, the circular body 604 is placed within the receiving flange 610. The flexible gasket 608 is either placed directly over the circular body 604 or into the ring 606 and then threaded onto the receiving flange 620.

To reduce the size of the system, the indicator can be incorporated into the body 604. In this embodiment the body 604 would be opaque with the lights (not illustrated) secured therein.

### Electrical and Communication Elements:

In some of the embodiments illustrated herein, the warning system has a base with at least two adjustable wings. The adjustability of the wings can be either through rotation, when attached to the base, or they can separate from the base and communicably connected to a base by wiring or wirelessly. Each wing contains an indicator, such as a light or siren, an optional shade, or cylinder, over or around the light, and a motion detector.

In other embodiments the electronics, including batteries if used, are incorporated within the wings which are connected to one another. The connection between the two wings should be rotatable, such as a hinge, to enable appropriate placement for detecting oncoming traffic.

In applicable applications, the wings can contain the electronics, activators, and indicators, each serving as an independent unit spaced from other units. The wings would be placed at the appropriate locations and connected to one another via wiring or wireless communication means. Although this would increase the size of the wings, it could eliminate the center base if applicable.

As noted heretofore the base can be eliminated and the electronics and power source would be maintained in the wings. For this embodiment, the size of the wings would need to be enlarged, and mounting means provided.

Although some uses of the warning system would not require a processor and external communication means, in some operations such as within construction zones, high-accident areas, and warehouses, traffic patterns can change requiring updating of sensor distance, type of indictor, etc. In applications where communication and control are preferable, it is preferable that a processor be remotely accessible and capable in to enable a change in programming to accommodate any required updates. A processor can also be used as a transceiver to signal a main monitoring facility that the system is working properly, requires repair, or whether unusual activity is indicated such as an accident. Additionally, the sensors can be connected to cameras within the wings to activate the cameras based on preprogrammed criteria with the processor as to normal traffic flow. For example, in the event of a rear-end accident, the traffic flow would be changed, cars could be stopped in their lane or moved to the emergency lane, etc. In the event of an anomaly, the cameras would be activated and a signal sent to a main monitoring facility. The use of a processor also enables a change in signal when backup power is activated where it can be beneficial, especially at busy blind intersections, to have continually flash warning lights to indicate a power failure.

The system is wired to enable the detectors within the wings to activate the indicators in the other wing, or wings. In some embodiments, as previously mentioned, detectors and indicators can be placed in the base as well as in the wings. The communication between the detectors and indicators can be either hardwired or through short range communication such as Bluetooth.

For example, in a two-wing hardwired system, without a processor, the signal from the detector would activate the indicator in the corresponding wing and would continue to send signals until movement is no longer indicated. This wired set-up would be the same for any number or combination of wings and/or bases.

For installations having a processor, the communication between the wings would preferably be via Bluetooth, Wi-Fi direct, NFC (Near Field Communication) or equivalent, with the communication signal received from the detector wirelessly to the indicator of the partnering wing(s). In situations where updates are required to be sent to a distant location, additional appropriate hardware would be required, the connection to which will be known in the art.

Where available, or accessible, the system is powered through an AC connection. In situations without available AC power, or as an AC backup, either standard batteries or batteries rechargeable through solar panels can be used to maintain operation. The addition of solar panels can also be an advantageous addition to systems using AC power to maintain operation in the event of power failure. When used, solar panels, due to size and access to sun, would be separated from the base and/or wings and would be directly connected to the base via standard wiring as known in the art. As solar and other applicable power source technology develops and size is reduced, it will be obvious to those skilled in the art as to their incorporation into the disclosed technology.

### Mounting Apparatus:

Depending on the embodiment, the device can be pole-mounted using an adjustable swivel base or attached using bolts attached to the side of the base portion or a bracket. All versions contain the operating circuitry within the base portion and wings, and all parts are water and weatherproof for sustained outdoor use.

It should be noted that the base can be secured to the applicable support in any manner known in the art. The criterion for mounting the base is to ensure that the detector and indicator face the intended direction and will vary based on the type of support. For example, when mounted on a pipe support, as described thereinafter, the base unit would be secured from the bottom. However, in applications where a bracket or, as illustrated in FIGS. 11a and 11b, an L-shaped support is used, the base unit can be mounted on either the top, or hung from the bottom, of the top support. The ability to mount the base unit in a number of manners depending upon the application also extends to the mounting of the wings.

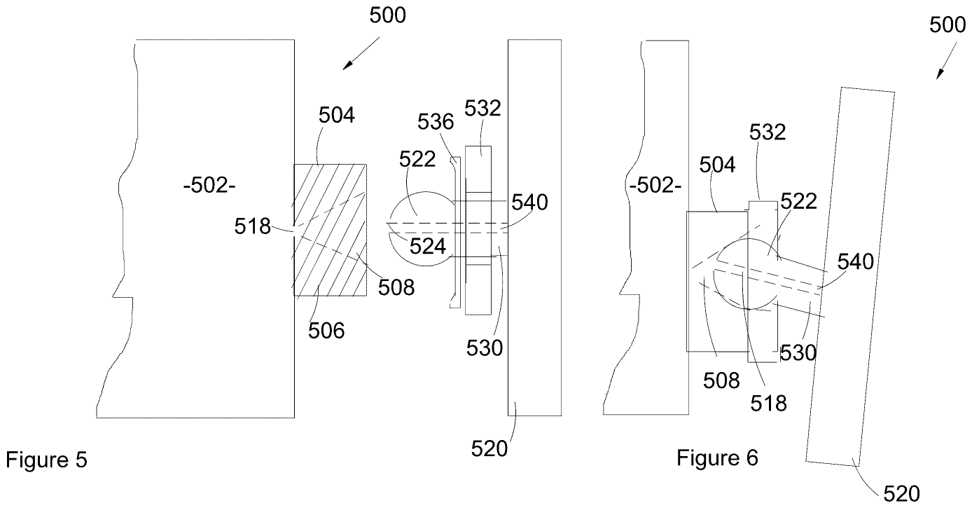

FIGS. 5 and 6 illustrate a swivel wing mount system 500 that enables the wings 520 to be rotated horizontally and vertically. The base mount 504 is threaded with exterior threads 506 and contains a receiving inlet 508 to receive a ball 522. The receiving inlet 508, in the illustrated example, is V-shape to enable pressure to be applied to the ball 522 in order to prevent unintended rotation. Further the surface of the ball 522 and/or the interior of the receiving inlet 508 can be roughened or scored to prevent rotation. The base mount 504 is molded as part of the base 502 or, if preferred, molded separately and subsequently affixed either removably or permanently. It is preferable that a passage 518 be provided into the base 502 from the receiving inlet 508 for the passage of wiring from the wing 520. As the depth of the mount 504 determines, along with the spacer 530 described hereinafter, the degree of wing 520 rotation, using a removable mount permits depth change and therefore rotation increase or decrease.

Although a V-shaped inlet is illustrated as an example, any configuration that can prevent unintended rotation can be used. This can include frustum, circle or cylinder with tabs, or other configurations that will be known in the art.

The wing 520 has a spacer 530 mounted at the back that extends a predetermined distance from the wing 520 to the ball 522. The spacer 530 can be screwed into the wing 520, molded as part of the wing 520, adhered using adhesive or any other method convenient to the material of manufacture. The spacer 530, at its point of attachment to the wing 520 and its connection to the ball 522, preferably contains a channel 540 to receive the electrical wiring required to power the indicator and sensor (not illustrated). The incorporation of the wiring channel 540 is preferable, however the wiring can also be external, extending from the wing 520 to the base 502. Whether the wiring is internal or external, sufficient wire should be provided to enable rotation of the wing 520 without placing stress on the wiring connections. Since the spacer 530 length will, in conjunction with the mount 504, determine the distance that the wing 520 can be tilted, easy disconnection and reconnection of the wired would be beneficial in some applications.

The ball 522 can be removable from the spacer 530 or the ball 522 and the spacer 530 can be molded as a single unit. Whether the spacer 530 is removable from the wing 520 or the ball 522 is removable from the spacer 530 is a matter of manufacturing convenience. However, as the threaded connector 532 is positioned between the wing 520 and the ball 522, one or both should be removable to enable placement of the connector 532 and gasket 536. If the system 500 is 3D printed the connection between the wing 520, spacer 530, connector 532 and the ball 522 can be a single printing with movable parts.

The connector 532 and gasket 536 have an open interior with a diameter smaller than the diameter of the ball 522. The connector 532 has a threaded interior configured to be received on the threads 506 of the mount 504 with the gasket 536 dimensioned to prevent interference with the threads. Once the wing 520 is positioned, the connector 532 and gasket 536 combination is tightened to place pressure on the ball 522 by forcing it into the inlet 508, thereby preventing movement.

Although the configuration disclosed in FIGS. 5 and 6 uses a connector to secure the ball 522 within the receiving inlet 508, this connection can also be snap-in, non-removable, or another method known to those skilled in the art.

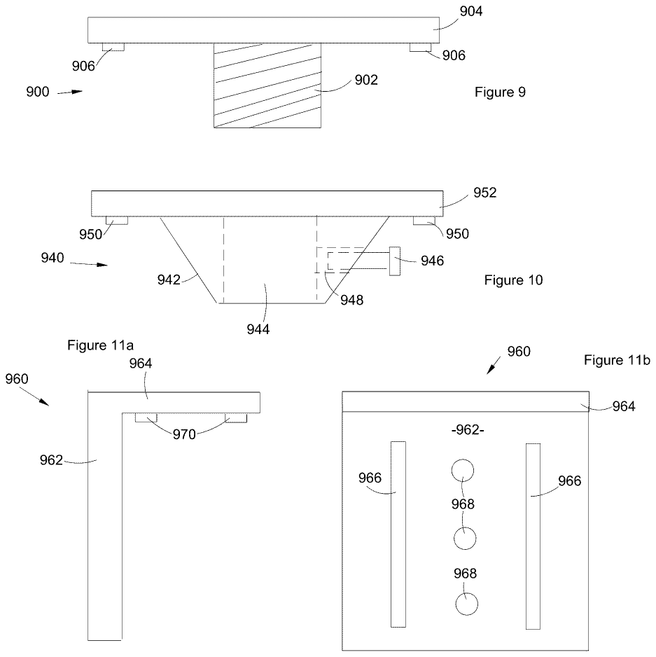

FIG. 9 is a side view of a mounting system for placement of the base (not illustrated) on the top of a pipe (not shown). The top of the receiving base 904 is dimensioned to receive, and securely support, the base, illustrated heretofore, which is secured thereto by bolts 906, or other means compatible with the materials, e.g., adhesive, bolts, screws, etc. The pipe mount base 902 is threaded on the interior, exterior, or both interior and exterior in order to accommodate two support pipe diameters. In instances where the pipe mount base 902 has exterior threads and is the same diameter as the support pipe, a coupling can be used for connection. It should be noted that the support pipe can be either vertically or horizontally mounted.

In FIG. 10 the pipe mount 940 is designed for use with unthreaded pipes. The mount body 942 is affixed to a receiving base 952 which, as noted above, is affixed to the base via securing members 950. The mount body 942 contains a pipe channel 944 dimensioned to receive the intended support pipe (not shown). The support pipe will be prevented from extending completely through the mount body 942 by the receiving base 952. The pipe channel 944 is placed over the pipe and is prevented from removal and/or rotational movement through the tightening of a securing member 946, such as a set screw or bolt, through channel 948, applying pressure against the pipe. This embodiment can be manufactured to accommodate any configuration of pipe.

FIGS. 11a and 11b illustrate an L-shaped mount 960 having a top plate 964 and a back plate 962. The top plate 964 is provided with mounting screws or bolts 970 that will serve to secure a base. The back plate 962 is provided with screw holes 968 as well as strap slots 966. This enables the mount 960 to be secured to a support through the use of bolts/screws or straps.

The L-shaped mount 960 illustrated in FIGS. 11a and 11b can be mounted at a variety of angles enabling flexibility for the directional placement of the base unit. A base can be mounted on the top surface of the top plate 964 or on the underside of the top plate 964.

### Broad Scope of the Invention

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims (e.g., including that to be later added) are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language of the present invention or inventions should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

While in the foregoing we have disclosed embodiments of the invention in considerable detail, it will be understood by those skilled in the art that many of these details may be varied without departing from the spirit and scope of the invention.

### PARTS LISTING

100 dual wing blind spot signal device
102 adjustable wing/traffic panel
104 adjustable wing/traffic panel
106 base panel
108 tensioner
110 tensioner
120 hinge
122 hinge
124 electrical wiring
126 electrical wiring
130 shade
132 shade
136 indicator
138 indicator
140 motion sensor
142 motion sensor
200 system
202 traffic panels
204 wing
206 base panel
208 tension nuts
210 tension nuts
230 shield
232 shield
236 indicator
238 Indicator
240 detector
242 detector
250 indicator
252 detector
300 system
302 wing
304 wing
306 base indicator
330 shield
332 shield
336 indicator
338 indicator
340 sensor
342 sensor
350 directional indicator
352 directional indicator
500 system
502 base
504 base mount
506 threads
508 receiving inlet
518 passage
520 wing
522 ball
530 spacer
532 connector
536 gasket
540 channel
536 gasket
600 system
602 sensor
603 wiring
604 circular body
606 connector ring
608 flexible gasket
620 receiving flange
902 pipe mount base
904 receiving base
906 bolts
940 pipe mount
942 mount body
944 pipe channel
946 securing member
948 channel
950 securing members
952 receiving base
960 L shaped mount
962 back plate
964 top plate
966 strap slots
968 screw holes
970 bolts
1000 system
1010 indicator unit
1012 indicators
1014 connectors
1016 wires
1020 indicator unit
1022 indicators
1024 connector
1026 wires
1030 base unit
1032 detector
1034 indicators
1040 detector unit
1042 sensor unit
1044 connectors
1046 wires
1050 detector unit
1052 sensor unit
1054 connectors
1056 wires
1102 traffic panel
1104 traffic panels
1108 face
1140 indicators
1142 sensors
1144 shields
1200 mounting panel system
1202 traffic panel
1204 traffic panel
1206 mounting panel
1500 detection system
1502 traffic panel
1504 traffic panel
1516 shaft
1540 indicator
1542 detector
1550 support
1552 wiring
1554 base unit

What is claimed is:

1. A warning system for visually obstructed environments comprising:
a. multiple traffic panels, each of said multiple traffic panels having:
i. a housing;
ii. at least one detector for registering motion within a line of sight and generating motion signals, said at least one detector adjustably attached to a surface of said housing; and
iii. at least one indicator for receiving said motion signals and providing a warning signal, said at least one indicator adjustably attached to a surface of said housing;
b. communication means to transmit said motion signals between said multiple traffic panels; and
c. a power supply;
wherein each of said multiple traffic panels is configured to be positionably adjustable;
wherein each of said multiple traffic panels faces a direction that is unviewable from at least one other direction;
wherein said motion signals are transmitted from said at least one detector in at least one of said multiple traffic panels to said at least one indicator in at least one of another of said multiple traffic panels; and
wherein said warning signal provided by one of said multiple traffic panels warns of motion within the line of sight of the at least one detector of another of said multiple traffic panels.

2. The system of claim 1 further comprising a central base housing said power supply and managing communication between each of said multiple traffic panels.

3. The system of claim 2 wherein said multiple traffic panels are rotatably attached to opposing sides of said central base.

4. The system of claim 1 wherein said power supply is contained within each of said multiple traffic panels.

5. The system of claim 4 wherein said at least two of said multiple traffic panels are rotatably connected to one another.

6. The system of claim 4 further comprising a center mounting panel, at least two of said multiple traffic panels being rotatably mounted on opposing edges of said center mounting plate.

7. The system of claim 2 wherein said central base further comprises at least one base indicator and at least one base detector, said at least one base indicator and said at least one base detector in communication with said multiple traffic panels.

8. The system of claim 1 wherein said communication means is wireless.

9. The system of claim 1 wherein said communication means is wired.

10. The system of claim 1 further comprising a processor to receive and transmit communication between said multiple traffic panels.

11. The system of claim 10 wherein said processor can control each of said at least one detector and said at least one indicator.

12. The system of claim 10 wherein said processor has two-way communication with a remote facility.

13. The system of claim 1 wherein said power supply is selected from at least one of batteries, AC power, solar or a combination thereof.

14. The system of claim 1 further comprising a mounting member to secure said system in a position for use.

15. The system of claim 1 wherein said multiple traffic panels are attached to a base panel by a swivel mount to enable said multiple traffic panels to be rotated vertically and horizontally.

16. A warning system for visually obstructed environments comprising:
a. multiple traffic panels, each of said multiple traffic panels having:
i. a housing;
ii. at least one detector for registering motion within a line of sight and generating motion signals, said at least one detector adjustably attached to a surface of said housing; and
iii. at least one indicator for receiving said motion signals and providing a warning signal, said at least one indicator adjustably attached to a surface of said housing;
b. communication means to transmit said motion signals between said multiple traffic panels;
c. a processor, said processor controlling said communication between said multiple traffic panels and a remote facility;
d. a base;
e. a support, said support maintaining said system in a predetermined position;
f. a mounting panel to secure said warning system to said support; and
g. a power supply;
wherein each of said multiple traffic panels is configured to be positionably adjustable;
wherein each of said multiple traffic panels faces a direction that is unviewable from at least one other direction;
wherein said motion signals are transmitted from said at least one detector in at least one of said multiple traffic panels to said at least one indicator in at least one of another of said multiple traffic panels; and
wherein said warning signal provided by one of said multiple traffic panels warns of motion within the line of sight of the at least one detector of another of said multiple traffic panels.

17. The system of claim 16 wherein said power supply is selected from at least one of batteries, AC power, and solar or a combination thereof.

18. The system of claim 16 wherein said base location is selected from at least one of between at least two of said multiple traffic panels, at ground level proximate said support, or affixed to said support.

19. The system of claim 17 wherein said power supply is located in at least one of within each of said multiple traffic panels or within said base.

20. The method of alerting traffic at a first location of traffic movement at a second, unseen location comprising the steps of:
a. mounting a detection system having multiple traffic panels, each of said multiple traffic panels having:
i. a housing;
ii. at least one detector for registering motion within a line of sight and generating motion signals, said at least one detector adjustably attached to a surface of said housing; and
iii. at least one indicator for receiving said motion signals and providing a warning signal, said at least one indicator adjustably attached to a surface of said housing;
iv. communication means to transmit said motion signals between said multiple traffic panels; and
v. a power supply;
b. mounting at least one of said multiple traffic panels facing a direction and mounting at least one other of said multiple traffic panels facing in at least one other direction;
wherein each of said traffic panels is positionably adjustable;
wherein each of said multiple traffic panels is mounted in a direction that is unviewable from at least one other direction;
wherein said motion signals are transmitted from said at least one detector in at least one of said multiple traffic panels to said at least one indicator in at least one of another of said multiple traffic panels; and
wherein said warning signal provided by one of said multiple traffic panels warns of motion within the line of sight of the at least one detector of another of said multiple traffic panels.
